(19) United States
(12) Patent Application Publication
(10) Pub. No.: US 2005/0124258 A1
(43) Pub. Date: Jun. 9, 2005

(54) Electroluminescent lamp construction and electroluminescent lamp made thereby

(75) Inventors: Gustaf T. Appelberg, Fairfield, CT (US); Douglas A. George, Watertown, CT (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: E-Lite Technologies, Inc.

(21) Appl. No.: 11/008,348

(22) Filed: Dec. 8, 2004

Related U.S. Application Data
(60) Provisional application No. 60/527,676, filed on Dec. 8, 2003.

(51) Int. Cl. H01J 9/00; H01J 9/24; H05B 33/10

(52) U.S. Cl. 445/24; 445/25

(57) ABSTRACT

A phosphor coated film laminate is produced in a continuous coil suitable for further processing to provide an electroluminscent lamp construction and lamp. Dielectric material is applied to the phosphor surface of the film laminate in a desired shape by screening or punching and electrical connections are formed on the front and read conductors of the EL lamp. A continuous coil of electroluminscent lamps and construction is also described.

### TECHNICAL FIELD

The present invention relates generally to electroluminescent lamps and deals more particularly with electroluminescent (EL) lamp construction and EL lighting systems. More specifically, the present invention provides a method for such EL lamps construction and EL lamps related apparatus for carrying out the method which is applicable to both parallel plate EL lamps and split electrode EL lamps.

### BACKGROUND OF THE INVENTION

It is know in the prior art to construct a parallel plate EL lamp by building up layers using conventional “silk screen” techniques to apply each stacked layer one on top of the other. One such prior art parallel plate EL lamp construction begins with producing separate screens which are schematically illustrated in FIG. 1(a-e) corresponding to the desired pattern shape of each specific laminate layers required. The resultant prior art parallel plate EL lamp generally designated 50 and its stacked construction sequence is shown in an exploded view and illustrated schematically in FIG. 2. Using the appropriate patterned screen 10, a silver ink bus bar 12 is screened over an indium tin oxide/polyester (ITO/PET) surface 14 to distribute electricity. Next using another patterned screen 16, a phosphor layer 18 is screened over the ITO/PET surface 14 using at least two passes to ensure adequate phosphor coverage to avoid the final lamp from having dark or dimly lit spots. Next using a yet different screen 20, a dielectric layer of barium titanate 22 is screened over the phosphor layer 18 and then with a further different patterned screen 24, a carbon ink rear electrode 26 is screened over the barium titanate layer 22. Finally, using a yet further different patterned screen 28, a silver ink bus 30 is screened onto the carbon ink rear electrode 26 to distribute electricity. Typically, the EL lamp is sandwiched or enveloped between outer clear sheets 38, 40 to seal the lamp and protect it from damage. Also, a desicant layer 42 is used between the outer clear sheet 38 and the ITO/PET layer 14.

The prior art parallel plate EL lamp construction using screen-printing for coating phosphor on clear conductive coated substrates and the lamps created thereby uses labor intensive, difficult and costly processes. These substrates, once coated with phosphor, are further fabricated to make small, highly patterned parallel plate EL lamps. One major problem with this approach is it is difficult to make uniform screen-printed EL coatings consistently. EL material manufacturing techniques and processes are taught in U.S. Pat. Nos. 5,019,748; 5,045,755; 4,534,743 and application Ser. No. 09/888,954 to produce an ITO phosphor film protected layer in a continuous roll and which patents are incorporated herein by reference eliminates the need to silk screen the phosphor layer which is very difficult to keep in close tolerance which in accordance with the present invention is maintained within a tenth of an inch across the width of the coil. The present invention overcomes the problem of the prior art related to depositing and maintaining a precise thickness layer of phosphor.

A further problem of the prior art relates to the bus bar element and its attachment to the ITO conductive layer. In the prior art, a bus bar element is first fabricated as a separate element and next attached to the ITO conductive layer using a suitable conductive adhesive or in another process silk screened on the ITO surface. The bus bar must also be made with a tab of some type to accept attachment from an external lead or conductor. The present invention overcomes the problem of the prior art related to making connections to the internal ITO conductive layer.

A yet further problem of the prior art relates to the potentially high losses, primarily losses of ITO and phosphor, that occur with and due to poor quality of ITO and to improper handling of the conductive film or through processing errors. The present invention overcomes the problem of the prior art related to the loss of ITO and phosphor that occurs in the prior art.

Accordingly, there is a long standing need therefore to provide a high quality phosphor coating on a clear conductive coated substrate as an OEM component for use in the EL industry particularly for use by screen printing vendors who would add the additional screening processes to complete the remaining steps to fabricate small, highly patterned parallel plate EL lamps. The OEM component of the present invention eliminates the cost, frustration and variability of applying a suitable phosphor coating for subsequent use on demand by screen printing vendors in the EL industry.

### SUMMARY OF THE INVENTION

A method for electroluminescent lamp construction is provided. The method includes the steps of first providing a continuous coil having a length and a width dimension of an electroluminescent phosphor coated conductor film comprising an internal conductive layer sandwiched between a phosphor particulate layer and a clear protective film layer collectively defining a front conductor laminate. The front conductor laminate is a phosphor coated conductive polyester film substrate. In a first construction, the conductive polyester film substrate is an ITO/PET (indium tin oxide-coated polyester) film. The phosphor particles are electrostatically deposited onto a UV-curable adhesive coating on the ITO surface. In a second construction, the conductive polyester film substrate is an Orgacon™ conductive coating on the polyester film with the phosphor particles being electrostatically deposited onto the Orgacon™ conductive coating. In a third construction, the conductive polyester film substrate is an ITO/PET film. The phosphor particles are mixed in a binder and a solvent slurry of the phosphor/binder mixture is applied to the ITO surface and oven dried. The front conductor laminate is a continuous coil having a width and length dimension typically in the range of 32 inches wide and 1200 feet in length. The coil of front conductor laminate is robust and easily handled and transported. The coil of front conductor laminate provides the OEM component or base for subsequent processes by a silk screen vendor or a laminator. The processes include the further steps of applying a dielectric layer on the phosphor surface side of the front conductor laminate and next applying a conductor layer on the dielectric layer and then attaching a connector to the internal conductive layer. The conductor layer on the dielectric layer defines a rear conductor laminate, and the front and rear conductors joined together define a parallel plate EL lamp.

Preferably the method includes the step of enveloping the laminated front conductor and rear conductor defining the EL lamp between clear sheets to seal the lamp and to provide protection for the lamp.

Preferably the method step of applying a dielectric layer further comprises the step of screen printing the dielectric layer on the phosphor layer.

Preferably, the method step of applying a dielectric layer on the phosphor surface side further comprises the steps of providing a continuous coil having a length and width dimension of a laminated dielectric coated conductive film comprising an aluminum foil conductive layer laminated between a dielectric layer and a clear protective film layer collectively defining a rear conductor laminate and laminating the dielectric coated conductive film to the phosphor coated conductor film. The rear conductor laminate is a continuous coil having a width and length dimension typically 32 inches wide and 1200 feet in length.

Preferably, the method further includes the step of cutting the rear conductor laminate in the desired size and shape of the EL lamp prior to the step of laminating the dielectric coated conductive film to the phosphor coated conductive film.

Preferably, the method further includes the step of punching out one or more pieces of the rear conductor laminate in the desired sizes and shapes of the parallel plate EL lamp during the step of laminating the dielectric coated conductive film to the phosphor coated conductor film.

Preferably, the method step of providing a continuous coil of an electroluminescent phosphor coated conductor film further includes the step of providing an ITO internal conductive layer.

Preferably, the method step of providing a continuous coil of an electroluminescent phosphor coated conductor film further includes the step of providing a conductive polymer internal conductive layer.

### BRIEF DESCRIPTION OF THE DRAWINGS

FIGS. 1(a-e) show in schematic representation form the separate screens typically used in the prior art parallel plate silk screen electroluminescent construction.

FIG. 2 is an exploded schematic view of the prior art parallel plate silk screen electroluminescent construction using separate screens for each specific laminate layer.

FIG. 3 is a flowchart of the method of the present invention for making a coil of phosphor coated conductor film laminate suitable for further use in the construction of an electroluminescent parallel plate lamp.

FIG. 4 is a schematic representation of apparatus for making the phosphor coated conductor film laminate in accordance with the method of the flowchart shown in FIG. 3.

FIG. 5 is a flowchart of the method of the present invention for making a coil of an alternate embodiment phosphor coated conductor film laminate suitable for further use in the construction of an electroluminescent parallel plate lamp.

FIG. 6 is a schematic representation of apparatus for making the phosphor coated conductor film laminate in accordance with the method of the flowchart shown in FIG. 5.

FIG. 7 is a flowchart of the method of the present invention using a solvent slurry for making a coil of phosphor coated conductor film laminate suitable for further use in the construction of an electroluminscent parallel plate lamp.

FIG. 8 is a schematic representation of apparatus for making the phosphor coated conductor film laminate in accordance with the method of the flowchart shown in FIG. 7.

FIG. 9 is a schematic plan view of a section of the phosphor coated conductor film laminate coil made using the apparatus illustrated in FIG. 4.

FIG. 10 is a flowchart of the method of the present invention for the construction of an electroluminescent parallel plate lamp using the phosphor coated conductor film laminate made in accordance with the method of the flowchart shown in FIG. 3.

FIG. 11 is a schematic representation of apparatus for construction of an electroluminescent parallel plate lamp in accordance with the method of the flowchart shown in FIG. 10.

FIG. 12a is a schematic plan view of a section of the coil of electroluminescent parallel plate lamps made using the apparatus illustrated in FIG. 11.

FIG. 12b is a schematic cross-section view of the section of the coil of electroluminscent parallel plate lamp illustrated in FIG. 12a.

FIG. 13 is a schematic plan view showing an electroluminescent parallel plate lamp with external conductors connected to the internal conductive layer connector and to the bus bar for providing AC voltage to illuminate the lamp.

FIG. 14 is a plan view of a section of the alternate embodiment phosphor coated conductor film laminate coil made using the apparatus illustrated in FIG. 6.

FIG. 15 is a flowchart of the method of the present invention for the construction of an electroluminescent parallel plate lamp using the phosphor coated conductor film laminate made in accordance with the method of the flowchart shown in FIG. 5.

FIG. 16 is a schematic representation of apparatus for construction of an electroluminescent parallel plate lamp in accordance with the method of the flowchart shown in FIG. 15.

FIG. 17 is a schematic plan view of a section of the coil of electroluminescent parallel plate lamps made using the apparatus illustrated in FIG. 16.

FIG. 18 is a schematic plan view showing an electroluminescent parallel plate lamp with external conductors connected to the internal conductive layer connector and rear conductor for providing AC voltage to illuminate the lamp.

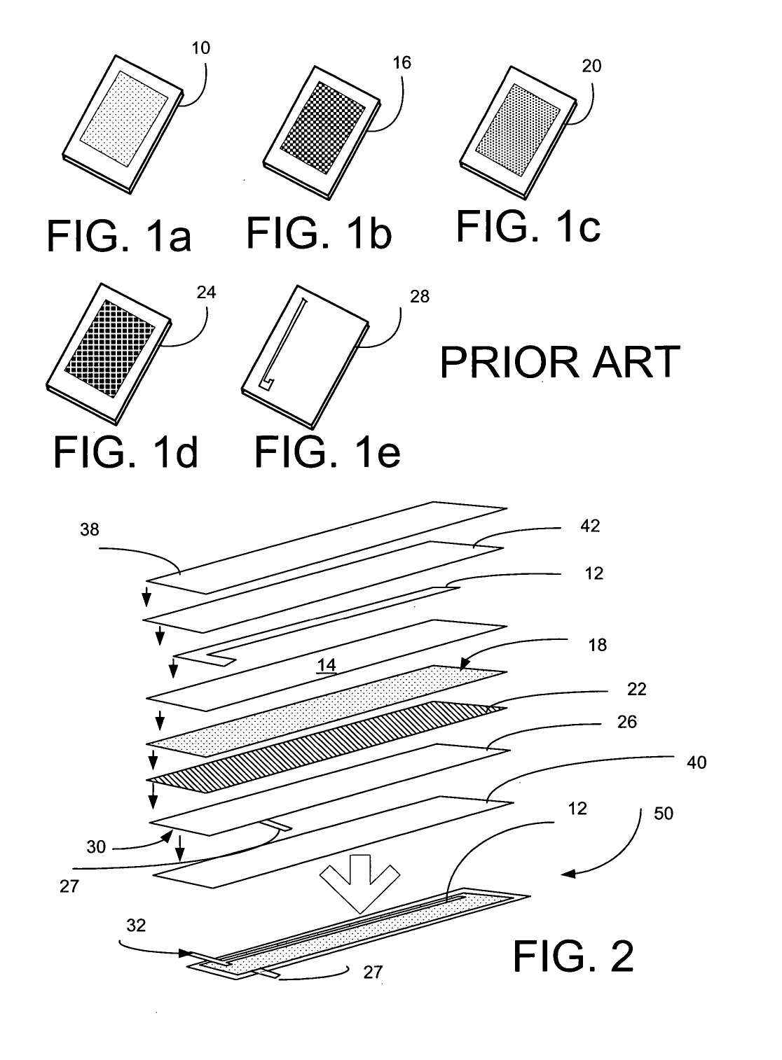

### DETAILED DESCRIPTION OF PREFERRED EMBODIMENTS

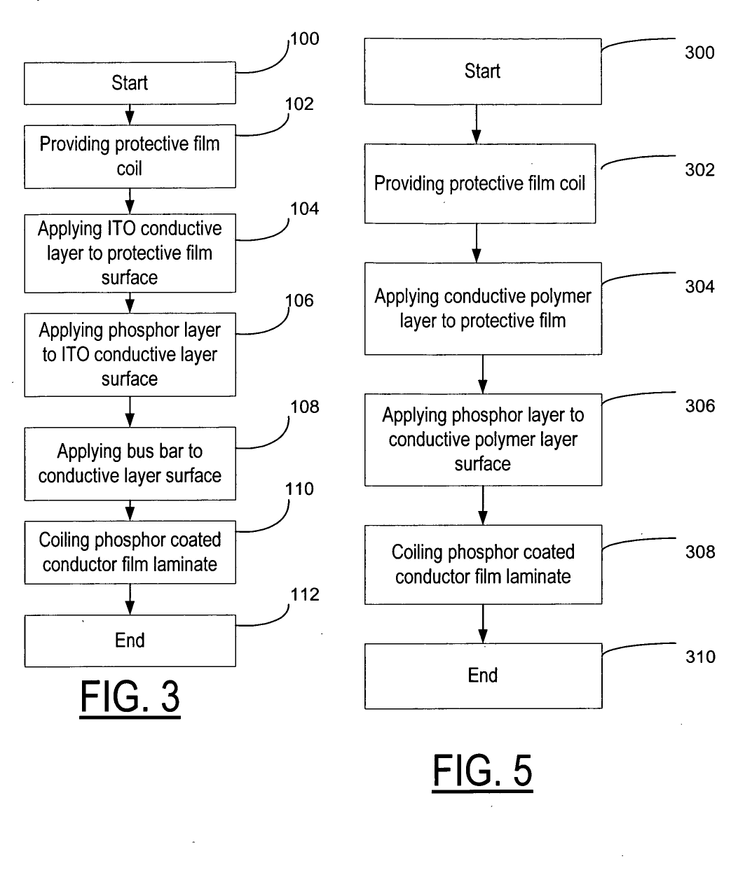

Turning now to the drawing figures and considering the invention in further detail, FIG. 3 shows a flowchart of one embodiment of the method of the present invention for making a coil of phosphor coated conductor film laminate suitable for further use in the construction of an electroluminescent parallel plate lamp. The method shown in FIG. 3 begins with the start step 100 and proceeds to providing a protective film coil or roll in step 102. The protective film coil is a continuous coil having for purposes of explanation, a width dimension of approximately 32 inches and a length dimension approximately 1200 feet in length although other width and length large scale dimensions are contemplated to be within the invention. The protective film continuous coil is made of a suitable material for web-to-web processing and typically is, for example, a clear polyester film (PET) which provides a moisture barrier and serves as a carrier for receiving additional structural layers as described herein. The process proceeds to applying an indium tin oxide (ITO) conductive layer to the surface of the protective film in step 104. The ITO conductive layer is applied to the protective film surface as the protective film roll is uncoiled or payed-off from the continuos coil. The process proceeds to applying a suitable phosphor particulate to the ITO conductive layer surface in step 106 in a suitable manner to provide a layer of phosphor particles embedded in a dielectric adhesive material coated on the ITO conductive layer. The phosphor layer pattern is applied to the ITO conductive layer surface in such a way that the phosphor particulate does not reach edge-to-edge so that a marginal region stripe of the ITO conductive layer surface is left exposed. The next step includes depositing or applying a suitable bus bar to the conductor layer surface in the marginal area in step 108. The process includes coiling the phosphor coated conductor film laminate with the bus bar applied in the marginal regional stripe area on the ITO conductive layer surface in step 110 and the method is completed with the end step 112. The continuous coil of the phosphor coated conductor film laminate is now in condition for sale and transport to another location to receive subsequent processing in the construction of an electroluminescent parallel plate lamp.

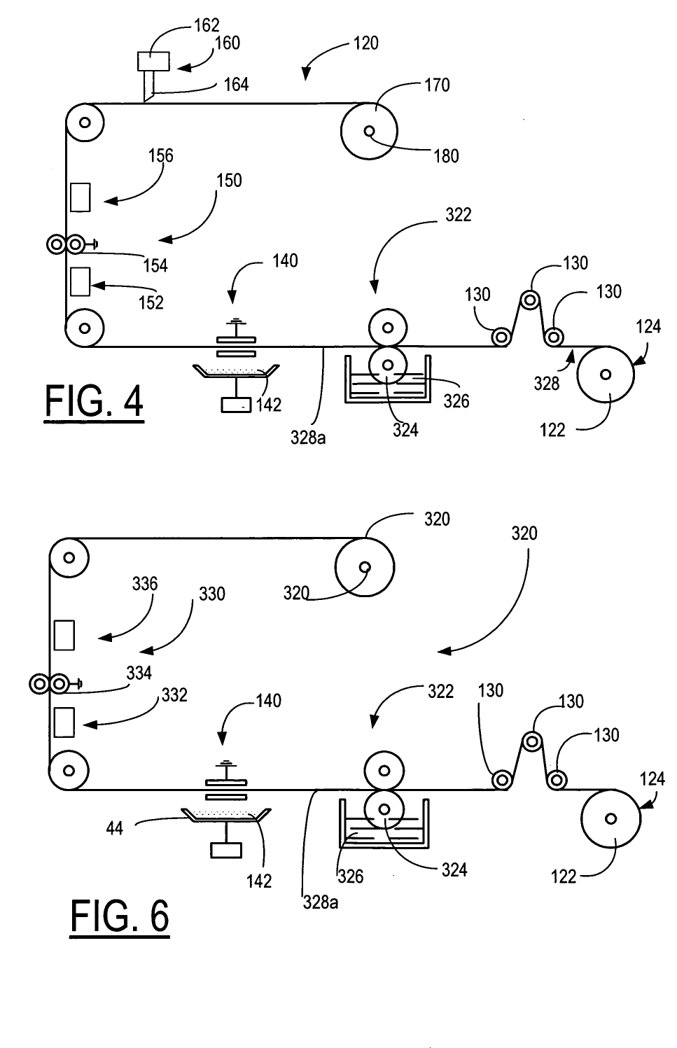

Apparatus for making the phosphor coated conductor film laminate in accordance with the method of the flowchart shown in FIG. 3 is illustrated schematically in FIG. 4 and generally designated 120. The apparatus is similar in many respects to apparatus described in U.S. Pat. Nos. 5,045,755 and 5,019,748 commonly owned by the Assignee of the present invention and the disclosures of which are hereby incorporated by reference. The apparatus 120 includes a pay-off reel 122 for holding a continuous coil carrier strip of a transparent insulating material generally designated 124 upon the surface of which a conductive coating 126, for example, an indium tin oxide (ITO) coating is applied to the side 128 of the carrier strip 124. The carrier strip 124 may be of any suitable transparent insulating material such as, for example, Mylar, a registered trademark of E.I. DuPont de Nemoures and Company, or preferably for example, a polyester (PET) film or other clear, flexible film. The carrier strip 124 moves through tensioning and aligning rollers generally designated 130, 130 past an adhesive application station generally designated 132 which includes an adhesive applying roll 134 which picks up, for example, a liquid radiation curable dielectric adhesive 136 and applies it as a thin layer on the surface of the ITO conductive coating 126. The adhesive layer has a high dielectric strength and is subsequently curable by radiation, for example, ultraviolet light. The carrier strip with the conductive coating and uncured dielectric adhesive layer moves continuously past a phosphor particulate depositing station 140 which includes a source 142 of phosphor particulate which is electrostatically deposited on or attracted to the uncured adhesive layer on the side 128a of the carrier film 124. The phosphor particles are preferably deposited in an approximate mono-layer and move past a curing station generally designated 150 wherein a first ultraviolet lamp 152 partially cures the adhesive layer upon which the phosphor particulate is deposited or embedded. Further embedding of the phosphor particulate is aided by the roller 154 which is a Teflon coated and height adjustable roller to finally set the phosphor particulate in the partially cured adhesive. The partially cured phosphor coated conductive film moves continuously past the ultraviolet lamp 156 to complete the curing of the adhesive with the embedded phosphor particulate. The phosphor coated conductive film moves past a conductive ink depositing station generally designated 160 which applies a bus bar of a suitable conductive ink along the marginal edge stripe of the exposed conductive ITO coating layer. The conductive ink may be applied using any suitable application means such as screening, printing, or depositing for example by ink-jet type printing heads or other means well known to those skilled in the art to transfer the conductive ink 162 via the application means 164 to the conductive coating. The phosphor coated conductor film laminate with the bus bar is taken up as a continuous coil or roll 170 on the take up reel 180.

A segment of the phosphor coated film laminate with a deposited bus bar attached is illustrated in the top plan view in FIG. 9 wherein the phosphor coated area is generally designated 172 between marginal edge regions 174 and 176 of uncoated conductive film. The bus bar 178 is deposited as a strip in the uncoated marginal edge region 176. The dimension of the uncoated edge regions 174, 176 are controlled by means of the adhesive applying roll 134 which applies the adhesive in accordance with the desired width of the phosphor to be applied to the conductive ITO surface.

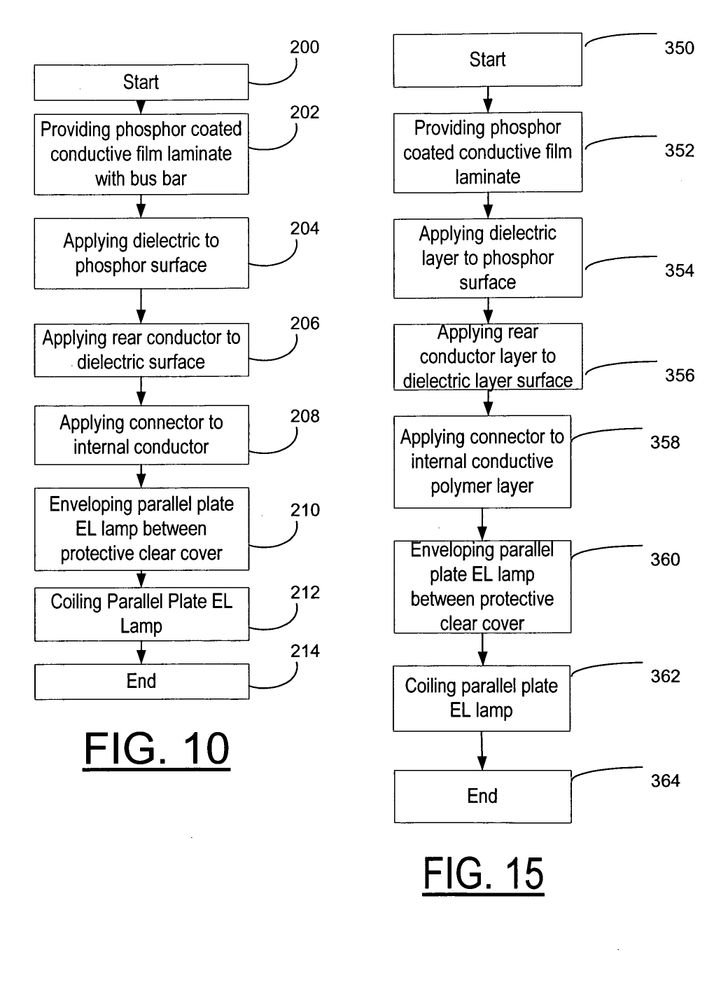

Turning now to FIG. 10, a flowchart of the method of the present invention for construction of an electroluminescent (EL) parallel plate lamp using the phosphor coated conductor film laminate made in accordance with the method of the flowchart shown in FIG. 3 and described above in connection with the description of FIGS. 4 and 9, is illustrated therein and begins with the start step 200 and continues in step 202 by providing continuous coil of a phosphor coated conductive film laminate with a bus bar deposited along a marginal edge region, such as the continuous coil laminate 170 described above. The process proceeds in step 204 by applying a suitable dielectric to the phosphor surface typically in accordance with the desired shape or silhouette of the parallel plate lamp. The process moves to step 206 and includes applying a suitable material to the dielectric surface to function as the rear conductor. A suitable connection means or connector to the internal conductor of the phosphor coated conductive film laminate to serve as the electrical connection to distribute electricity to the parallel plate lamp is applied and carried out in step 208. Enveloping, laminating or encasing the parallel plate EL lamp between protective clear covers is carried out in step 210. The method continues with coiling the enveloped parallel plate EL lamp in step 212 to provide a continuous coil of parallel plate EL lamps to complete the process which ends with the end step 214.

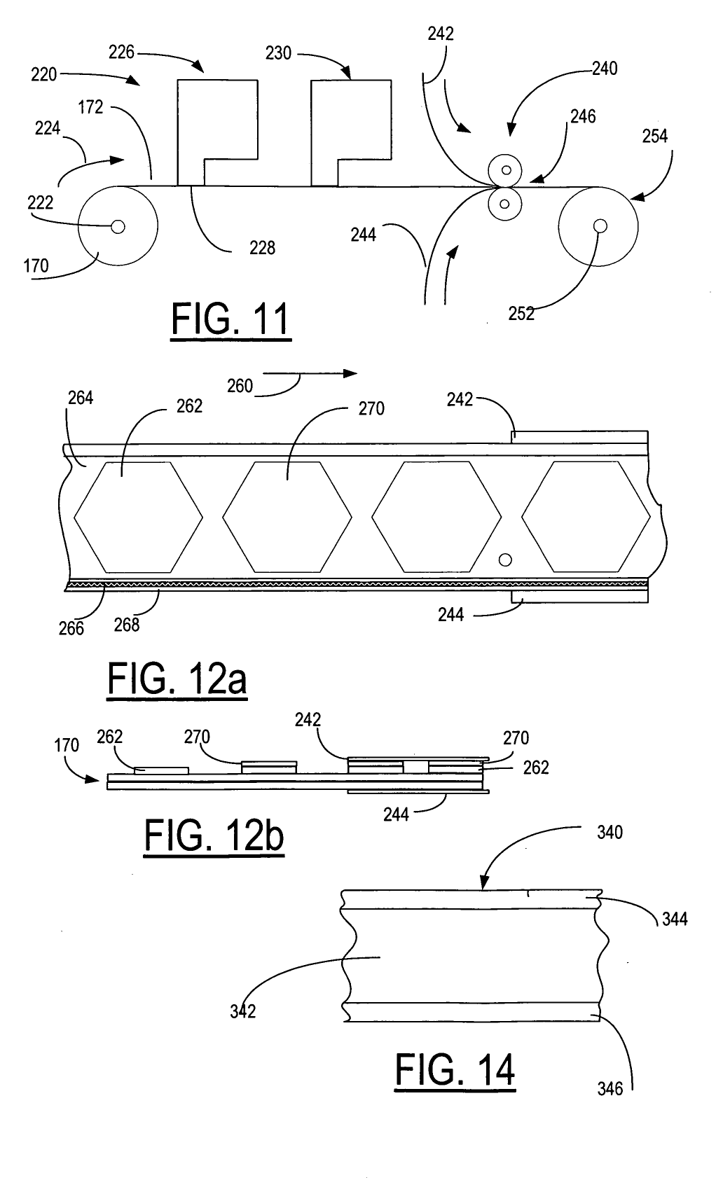

A schematic representation of apparatus for construction of an electroluminescent parallel plate lamp in accordance with the method of flowchart shown in FIG. 10 is illustrated in FIG. 11 and generally designated 220. A continuous coil of a phosphor coated conductive film laminate with a power bus bar 170 is provided on a pay-off roll 222 and moves in a continuous manner in the direction of arrow 224 past a dielectric application station generally designated 226. A dielectric material is applied or printed on the surface 172 at the station 226 via an application head 228, by means of a screening process, printing process or other application means suitable to carry out the intended function and well known to those skilled in the art. The dielectric material is applied in accordance with the desired pattern or shape of the parallel plate EL lamp under construction. The dielectric is then cured or dried. The phosphor coated film laminate with the applied dielectric moves in a continuous fashion past a rear conductor application station generally designated 230 which applies or deposits material over the dielectric surface forming the rear conductor to form the parallel plate EL lamp. The rear conductor is then cured or dried. The lamp so formed moves past a laminating or enveloping station generally designated 240 which envelopes or encases the parallel plate EL lamp between protective clear covers or films generally designated 242, 244 and which covers are applied in a continuous manner as the parallel plate EL lamps move through the laminating nib 246 formed between rollers 248 and 250. The enveloped parallel plate EL lamps are taken up in a continuous coil generally designated 254 on a take up reel 252. FIG. 12a is a schematic top plan view of a section of the coil of the electroluminescent parallel plates lamps made using the apparatus illustrated in FIG. 11 wherein the lamp construction occurs in the direction of the arrow 260 showing the silhouette of the dielectric 262 applied on the phosphor surface 264 of the phosphor coated conductive film laminate with the bus bar 266 applied to the uncoated internal conductor 268 along the marginal edge. The rear conductor coated dielectric surface represented by the area 270 completes the construction of the parallel plate electroluminescent lamp. As the roll or film moves toward the laminating station, the clear protective covers 242, 244 are applied to sandwich or encase the parallel plate electroluminescent lamp. FIG. 12b is a schematic cross-section view of the section of the coil of electroluminescent parallel plate lamps illustrated in FIG. 12a wherein like reference numbers represent like parts. FIG. 13 is a schematic plan view showing an electroluminscent parallel plate lamp cut from the coil of parallel plate lamps such as illustrated in FIGS. 12a and 12b wherein an external connection is made to the bus bar 266 and an internal connection 280 is made through the lamp to the internal conductive coating 176 such that external conductors or wires 282, 284 provide an electrical connection to the rear conductor via the connector 280 and the internal conductor via the bus bar 266 such that an appropriate voltage potential applied across the two conductors 282, 284 cause the parallel plate electroluminescent lamp to illuminate.

Turning now to FIG. 5, a flowchart of an alternate embodiment of the method of the present invention is illustrated therein for making a continuous coil of a phosphor coated conductor film laminate suitable for use in the construction of an electroluminescent parallel plate lamp. The method begins with the start step 300 and continues with providing a protective film coil or roll in step 302. The protective film coil is a continuous roll having for purposes of explanation a width dimension of approximately 32 inches and a length dimension approximately 1200 feet in length although other width and length dimensions are contemplated to be within the invention. The protective film continuous coil is made of a suitable material such as, polyester (PET) for web-to-web processing and is clear and provides a moisture barrier and serves as a carrier for receiving additional layers as described herein. The next step shown in step 304 includes applying a suitable conductive polymer layer for example a coating or Orgacon™ to one side of the protective film across the width of the film. The next step includes applying a phosphor layer to the conductive polymer layer surface in step 306 in a suitable manner to provide preferably a mono-layer of phosphor embedded in the conductive polymer layer surface. The phosphor layer is applied to the conductive polymer layer surface in such a way that the phosphor does not reach to edge-to-edge and a marginal region stripe of the conductive polymer layer surface is left exposed. The process moves to step 308 and includes coiling the phosphor coated conductor film laminate into a roll and the method is completed with the end step 310. The continuous coil of the phosphor coated conductor film laminate is now in condition for sale and transport to another location to receive subsequent processing such as silk screening or punch and cut in the construction of an electroluminescent parallel plate lamp.

Apparatus for making the phosphor coated conductor film laminate in accordance with the method of the flowchart shown in FIG. 5 is illustrated schematically in FIG. 6 and is generally designated 320. The apparatus 320 in FIG. 6 is similar in many respects to the apparatus illustrated in FIG. 4 described herein above and like parts have like reference numerals. The apparatus 320 includes a pay-off reel 122 for holding a continuous coil carrier strip of a transparent insulating material generally designated 124 which moves through tensioning and aligning rollers generally designated 130, 130. The carrier strip 124 moves past a conductive polymer application station generally designated 322 which includes a conductive polymer applying roll 324 which picks up, for example, a suitable liquid conductive polymer 326 and applies it as a thin layer on the surface 328 of the carrier strip 124. The carrier strip with the conductive polymer coating is then moved continuously past a phosphor particulate depositing station 140 which includes a source 142 of phosphor particulate which is electrostatically deposited on or attracted to the conductive polymer layer on the side 328a of the carrier film 124. The phosphor particles are deposited preferably in an approximate mono-layer and move past a curing station generally designated 330 wherein the conductive polymer and embedded phosphor particulate is partially dried by suitable drying means 332 intended to carry out the drying function. Further embedding of the phosphor particulate to a precise height is aided by the roller 334 which is Teflon® coated and height adjustable. The partially dried conducive polymer phosphor embedded carrier strip moves past the final drying means 336 to complete the drying of the conductive polymer with the embedded phosphor particulate. The phosphor coated conductive film laminate is taken up as a continuous coil 340 on the take up reel 180. A segment of the phosphor film laminate is illustrated in the top plan view of FIG. 14 wherein the phosphor coated area is generally designated 342 with marginal edge region stripes 344 and 346 of uncoated conductive film.

Turning now to FIG. 15, flowchart of the method of the present invention for construction of an electroluminescent parallel plate lamp using the phosphor coated conductive film laminate made in accordance with the method of the flowchart shown in FIG. 5 and described above in connection with the description of FIGS. 6 and 14, is illustrated therein and begins with the start step 350. The method includes providing in step 352, a continuous coil of a phosphor coated conductive film laminate, such as the continuous coil 340 described above. The process moves to step 354 and includes applying a dielectric material to the phosphor surface wherein the dielectric is typically applied in accordance with the desired shape or silhouette of the EL parallel plate lamp. The method proceeds to step 356, and includes applying a suitable material to the surface of the dielectric layer applied in step 354 to function as the rear conductor. The process includes in step 358, applying a suitable connection means or connector to the internal conductive polymer layer to serve as the electrical connection to distribute electricity to the EL parallel plate lamp. Next laminating or enveloping the parallel plate electroluminescent lamp between protective clear covers is carried out in step 360. Alternately, the EL lamp can be coated by any suitable means. Coiling the enveloped parallel plate EL lamp in step 362 provides a continuous coil of the parallel plate EL lamps to complete the process which ends with the end step 364.

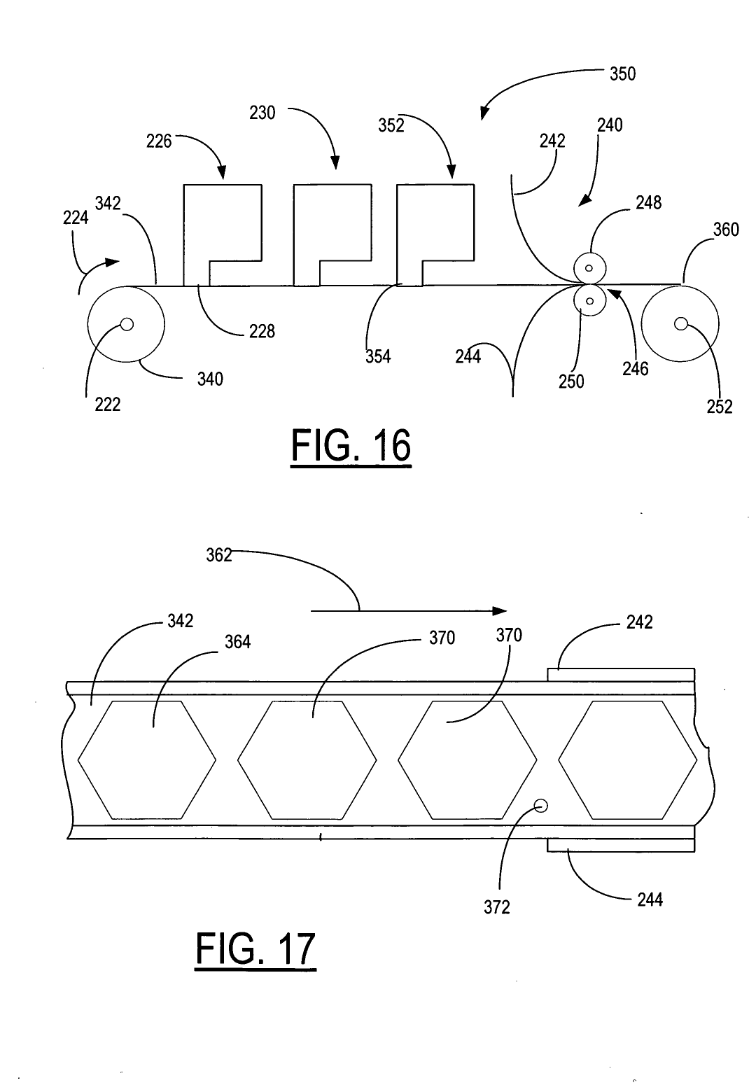

A schematic representation of apparatus for construction of an electroluminescent parallel plate in accordance with the method of the flowchart shown in FIG. 15 is illustrated in FIG. 16 and generally designated 350. A continuous coil or roll of a phosphor coated conductive film laminate 340 is provided on a pay-off roll 222 and moves in a continuous fashion in the direction of arrow 224 past a dielectric application station generally designated 226. A dielectric material is applied or printed on the surface 342 at the station 226 via an application head 228, by means of a screening process, printing process, or other application means suitable to carry out the intended function and which application means are well known to those skilled in the art. The dielectric material is applied in accordance with the desired pattern or shape of the parallel plate EL lamp under construction. The phosphor coated film laminate with the applied dielectric moves next in a continuous fashion past a rear conductor application station generally designated 230 which applies or deposits material forming the rear conductor over the dielectric surface to form the parallel plate EL lamp. The lamp so formed moves past a front conductor connector attaching application station generally designated 352 which applies or deposits a suitable connection means to the phosphor via the application head 354. The connection to the phosphor layer may be made using a screening process, printing process or other application means well known to those skilled in the art. The parallel plate EL lamp so formed moves past a laminating or enveloping station generally designated 240 which encases the parallel plate EL lamp between protective clear covers or films generally designated 242, 244 and which covers are applied in a continuous manner as the parallel plate EL lamps move through the laminating nib 246 formed between rollers 248 and 250. Alternately, the EL lamp can be coated by any suitable means. The enveloped or encased parallel plate EL lamps are taken up in a continuous coil generally designated 360 on the take up reel 252.

FIG. 17 is a schematic top plan view of a section of the coil of electroluminescent parallel plate lamps made using the apparatus illustrated in FIG. 16 wherein the lamp construction occurs in the direction of the arrow 362 showing the silhouette of the dielectric material 364 applied or deposited on the phosphor surface 342 of the phosphor coated conductive film laminate 340. The rear conductor coated dielectric surface represented by the area 370 completes the construction of the parallel plate electroluminescent lamp and serves as one connection point to distribute electricity to the parallel plate lamp. As the film laminate moves in the direction of arrow 362, a conductive connector 372 is attached to the conductive polymer layer to form the other electrical contact for distributing electricity to the parallel plate lamp. As the film laminate moves through the laminating station, the clear protective covers 242, 244 are applied to sandwich the parallel plate electroluminescent lamp.

FIG. 18 is a schematic plan view showing an electroluminescent parallel plate lamp cut from the coil of parallel plate lamps such as illustrated in FIG. 17 wherein an external connection is made via the internal connection 372 and the connection 374 on the rear conductor 370 such that external conductors or wires 282, 284 provide the necessary electrical connection to the rear conductor and the internal conductor such that an appropriate voltage potential applied across the two conductors 282, 284 cause the EL parallel plate electroluminescent lamp to illuminate.

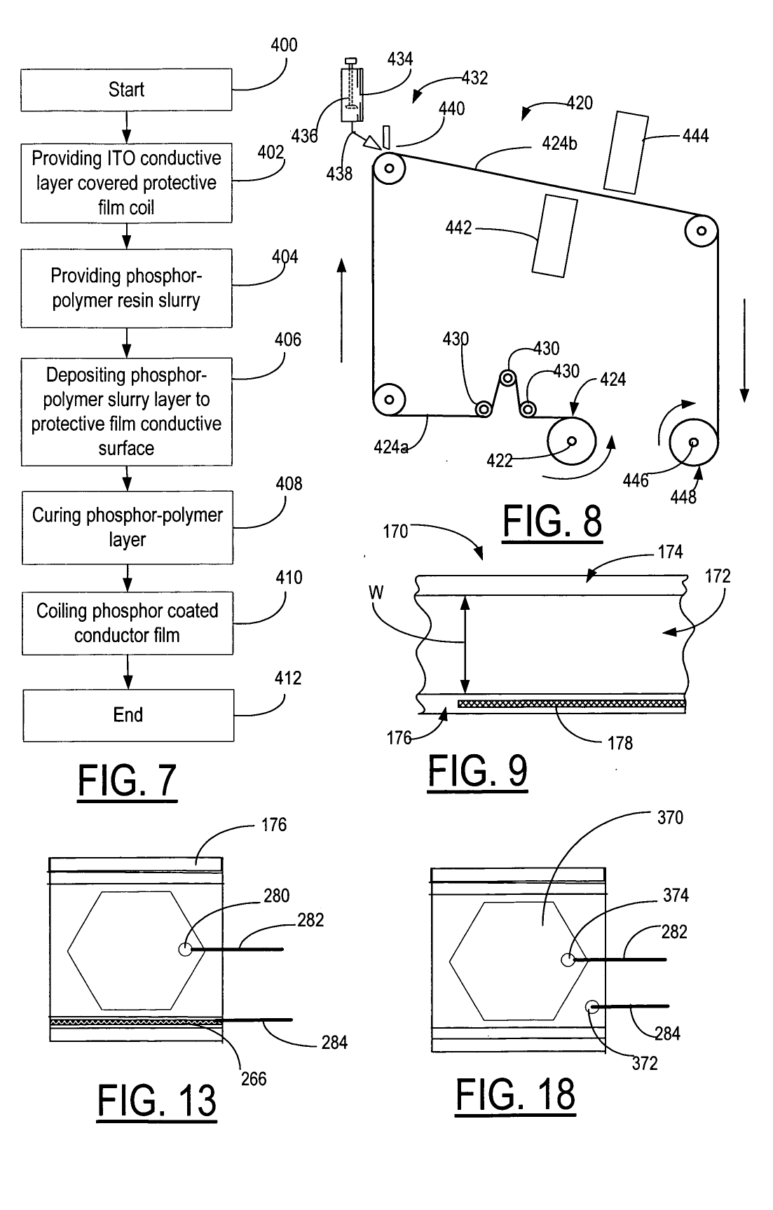

FIG. 7 shows a flowchart of a third embodiment of the method of the present invention for making a coil of phosphor coated conductor film laminate suitable for further use in the construction of an electroluminescent parallel plate lamp. The method shown in FIG. 7 begins with the start step 400 and proceeds to the step of providing an ITO conductive layer covered protective film coil or roll in step 402. The ITO conductive layer covered protective film coil is a continuous coil having for purposes of explanation, a width dimension of approximately of 32 inches wide and a length dimension of approximately 1200 feet although other width and length large scale dimensions are contemplated to be within the invention. A phosphor polymer resin slurry is provided wherein the phosphor particles are mixed with a suitable binder and carried in a solvent slurry mixture in step 404. The method then moves to step 406 wherein a layer of the phosphor polymer slurry is deposited to the protective film conductive surface. The phosphor polymer slurry layer is then dried and cured in step 408 and the phosphor coated conductor film is coiled in step 410 into a continuous coil or roll and the method is completed with the end step 412. It should be noted that as in the other embodiments of the method, the protective film coil moves continuously through the various steps.

Apparatus for making the phosphor coated conductor film laminate in the accordance with the method of the flowchart shown in FIG. 7 is shown schematically in FIG. 8 and generally designated 420. The apparatus 420 includes a pay-off reel 422 for holding a continuous coil carrier strip of an ITO conductive layer cover protective film coil generally designated 424 which moves through tensioning and aligning rollers generally 430, 430. The carrier strip 424 moves past a slurry depositing station generally designated 432 which includes a slurry reservoir 434 for a slurry of phosphor particles in a suitable polymer binder and a mixer 436 for maintaining a uniform as possible distribution of phosphor particulates in the slurry. A slurry supply 438 conveys the slurry to the knife over roller depositor 440. The slurry is deposited onto the protective film conductive surface 424a and the slurry is deposited on the surface as the carrier strip moves there past. Following the depositor 440, the as deposited phosphor slurry is then cured first from the bottom shown by the IR lamp 442 and then cured from the top side 424b by the IR lamp 444. The curing sequence is preferred to ensure a fully cured polymer resin phosphor layer. The phosphor slurry is a slurry of uncured polymer resin and phosphor particles (400 mesh) having a viscosity of 1,000 CPS. The polymer component of the slurry may be any suitable polymer to carry out the intended purpose. Once the phosphor polymer slurry is cured by the lamps 442, 444, the carrier strip is coiled on a take up reel 446 to form a continuous coil of the phosphor coated conductor film generally designated 448.

A predefined lamination construction parallel plate EL lamp is achieved by laying a rear conductor laminate in a dielectric deposited face-to-phosphor deposited face of front conductor laminate. A metal pattern of the desired shape and configuration and desired graphics or text is mounted on a ram and the metal pattern is heated to a predetermined temperature. The ram then moves the pattern into pressing contact with the foil side or rear conductor bringing the face side in contact with the face side or phosphor side of the front conductor. The heated pattern causes the barium titanate on the surfaces to soften and melt and provides an adhesive between the faces of the rear conductor and front conductor rolls in the areas contacted by the metal pattern to create an EL lamp having a pre-designated impression in accordance with the metal pattern.

A conductive ink which can be UV curable or a solvent based conductive ink is printed on the rear electrode or a connector is crimped to rear conductor to form one connection point for a power lead. A thermal curable non-solvent based conductive ink is printed on the front conductor to form the other connection point for a power lead. The thermal curable non-solvent based ink pierces the phosphor layer to make contact to the of the front conductor. Since the conductor ink is applied after the pre-designated impression is made, there is no limit to the size of the EL lamp nor does the EL lamp have to be piecemeal constructed with pre-cut pieces. The rear electrode can be punched in the desired shape and then heat/pressure laminated to the front electrode, or can be a heat stamped lamination or a pre-defined lamination. Since the rear conductor laminate and front conductor laminate material are on rolls, it is easy to construct EL lamps at high speed without registration problems or matching pre-cut pieces. The EL lamps can also be constructed having different shapes and sizes without changing the roll materials since only the area of the desired EL lamp changes and can be accommodated up to the full width and length of the rolls.

A method and related apparatus has been described in several embodiments for providing an electroluminescent lamp construction and an EL lamp made thereby. Although the method is well suited for parallel plate EL lamp construction, the processes are equally well suited for construction of split electrode EL lamps. Numerous changes and modifications may be made by those skilled in the art based on the teachings of the invention without departing from the spirit and scope of the invention contemplated herein. Therefore, the present invention is described by way of example and not limitation.

1. Method for electroluminescent (EL) lamp construction comprising the steps of:
providing a first continuous roll having a length and a width dimension of an electroluminescent phosphor coated conductor film comprising a conductive layer laminated between a phosphor particulate layer and an optically clear protective film layer and defining a front conductor laminate;
applying a dielectric layer on the phosphor surface side of the front conductor laminate;
applying a conductor layer on the dielectric layer and defining a rear conductor laminate; joining said front and rear conductor laminates defining a parallel plate EL lamp, and
attaching a connector to the conductive layer.

2. The method of claim 1 further including the step of providing an ITO conductive layer.

3. The method of claim 1 further including the step of providing a polymer conductive layer.

4. The method of claim 1 further including the step of enveloping the joined front conductor and rear conductor laminates defining the parallel plate EL lamp.

5. The method of claim 1 wherein the step of applying a dielectric layer further comprises the step of printing the dielectric layer on the phosphor layer.

6. The method of claim 1 wherein the step of applying a dielectric layer on the phosphor surface side further comprises the steps of:
providing a dielectric coated conductive film comprising an aluminum foil conductive layer laminated between a dielectric layer and an optically clear protective film layer and defining a rear conductor, and
laminating the dielectric coated conductive film to the phosphor coated conductor film.

7. The method of claim 6 further including the step of cutting the rear conductor in the desired size and shape of the parallel plate EL lamp prior to the step of laminating the dielectric coated conductive film to the phosphor coated conductive film.

8. The method of claim 6 further including the step of punching out one or more pieces of the rear conductor in the desired sizes and shapes of the parallel plate EL lamp during the step of laminating the dielectric coated conductive film to the phosphor coated conductor film.
